(19) United States
(12) Patent Application Publication
(10) Pub. No.: US 2009/0037702 A1
(43) Pub. Date: Feb. 5, 2009

(54) Processor and data load method using the same

(75) Inventors: Hideki Matsuyama, Kanagawa (JP); Masayuki Daitou, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/216,956

(22) Filed: Jul. 14, 2008

(30) Foreign Application Priority Data
Aug. 1, 2007 (JP) 2007-200606

(51) Int. Cl. G06F 9/312

(52) U.S. Cl. 712/225; 712/E09.033

(57) ABSTRACT

A processor includes an instruction decoder, an instruction execution part and a register file. The instruction decoder is adapted to decode an instruction. The instruction execution part is adapted to execute processing corresponding to the instruction decoded by the instruction decoder. The register file is capable of storing load data from a data memory and supplying input data to the instruction execution part. The register file includes a plurality of registers, each of which is capable of holding a plurality of bits of data. Furthermore, the register file is configured to update the data held by the plurality of registers by shifting the data held by the plurality of registers among the plurality of registers.

### BACKGROUND OF THE INVENTION

1. Field of the Invention

The present invention relates to processors such as a microprocessor and a DSP (Digital Signal Processor), and more particularly, to a data load technique reading out unaligned data block from a data memory to a register file included in the processor.

2. Description of Related Art

Processors such as a microprocessor and a DSP (Digital Signal Processor) are adapted to handle data by setting a predetermined data length to unit. Many processors which have currently been used set the unit to 32 bits (4 bytes) or 64 bits (8 bytes). This unit is called “word”. When the data unit of the processor is set to 64-bit unit, 32-bit unit may often be called “word” and 64-bit unit “doubleword” according to customary practice. A register length of registers provided in the processor is in size capable of storing data of one word or an integral multiple thereof.

The data unit of a peripheral device such as a data memory connected to the processor is defined based on the data unit of the processor as well. Accordingly, the data processing speed between the processor and the peripheral device can be increased. For example, a line width of a cache memory connected to the processor is defined as one word or the integral multiple thereof in accordance with the data unit of the processor. Accordingly, the processor can effectively load the data of one word or the integral multiple thereof into the register in the processor by one cache access.

When data of one word unit is stored in the data memory immediately after data less than one word is stored, the data may be stored with crossing a boundary of one word unit (word boundary) or a line boundary of the data memory (also called cache line boundary). The term “unaligned data” in the specification means one word data stored with crossing the word boundary. The term “unaligned data block” in the specification means the unaligned data having a data length twice or more larger than a register length of the processor, which is the data length of two or more words, and having a data boundary not corresponding to the word boundary of the data memory.

In order to align and load unaligned data into the register in the processor, a MIPS instruction set, which is a representative instruction set, includes an LWL (Load Word Left) instruction, an LWR (Load Word Right) instruction, an LDL (Load Double-word Left) instruction, and an LDR (Load Double-word Right) instruction, for example. By executing these instructions by combining them, the load of the unaligned data can be executed by two memory accesses. Hereinafter the LWL instruction, the LWR instruction, the LDL instruction, and the LDR instruction are collectively called “unaligned load instruction”. The detailed description of the unaligned load instruction defined by the MIPS instruction set is described in pages 205 to 209 and 222 to 228 of the document dated Jul. 1, 2005 by MIPS Technologies Inc., entitled “MIPS64 (R) Architecture For Programmers Volume II: The MIPS64 (R) Instruction Set”.

As an example, the load processing of the unaligned data employing the LDL instruction and the LDR instruction will be described with reference to FIG. 9. A data memory 51 shown in FIG. 9 has a line width of 64 bits and stores data X0 to X19 in five lines in total. Each of the data X0 to X19 has a length of 16 bits. Hereinafter, a case in which the 64-bit processor loads the four data X1 to X4 from the data memory 51 of FIG. 9 to store the loaded data in the register R8 will be considered. As shown in FIG. 9, the boundaries of the four data X1 to X4 do not correspond to line boundaries of the data memory 51. Since the line width of the data memory 51 is 64 bits, which is the same as the word unit of the 64-bit processor, the line boundaries are equal to the word boundaries.

The 64-bit processor employing the MIPS instruction set can load X3, X2, and X1 from the line of 0000h by execution of the LDR instruction to store them in the register R8 in right alignment. Further, the 64-bit processor can load X4 from the line of 0004h by execution of the LDL instruction to store the X4 in the register R8 in left alignment.

As stated above, when the unaligned load instruction including the LDL instruction and the LDR instruction is used, two instructions in total need to be executed in order to load one unaligned data (X1 to X4, for example) whose data length is equal to a word unit into the processor. Therefore, as shown in FIG. 10, at least eight instructions, more specifically, four LDL instructions and four LDR instructions need to be executed in total in order to load the unaligned data block X1 to X16 having data length of four words from the data memory 51 to the registers R0 to R3, for example. Generally, the load instruction of the unaligned data needs to be executed 2N times in order to load the unaligned data block having the data length of N words in the register file in the processor.

As stated above, we now faces the problem that a number of instructions need to be executed in order to load the unaligned data block in the register file in the processor. Due to this problem, the execution time of the digital filter processing may be increased when this processing including a lot of processings employing the unaligned data block is executed with the processor.

### SUMMARY

According to a first aspect of the present invention, there is provided a processor including an instruction decoder, an instruction execution part and a register file. The instruction decoder is adapted to decode an instruction. The instruction execution part is adapted to execute processing corresponding to the instruction decoded by the instruction decoder. The register file is capable of storing load data from a data memory and supplying input data to the instruction execution part. The register file includes a plurality of registers, each of which is capable of holding a plurality of bits of data. Furthermore, the register file is configured to update the data held by the plurality of registers by shifting the data held by the plurality of registers among the plurality of registers.

As described above, according to the processor of the first aspect of the present invention, the data held in the plurality of registers in the register file can be shifted among the plurality of registers. According to the processor thus configured, the unaligned data block stored in the data memory can be loaded into the register file by a simple procedure exemplary described below.

For example, the processor repeatedly executes an instruction (hereinafter this instruction is called aligned load instruction) for loading data (hereinafter this data is called aligned data) aligned according to a word boundary of a data memory to forward a plurality of aligned data in a range including the unaligned data block from the data memory to the register file. Then the processor executes a shift instruction for performing a data shift operation of the register file to shift held data among the registers holding the plurality of aligned data. Accordingly, the processor is able to store the unaligned data block with being aligned in the plurality of registers.

According to the above proceedings, the unaligned data block of N-word length can be loaded into the register file by the execution of N+1 aligned load instructions and one shift instruction. In other words, according to the processor of the first aspect of the present invention, it is possible to execute the aligned load processing of the unaligned data block with fewer instructions than in the proceedings in which the unaligned load instruction needs to be executed 2N times as shown in the related art.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram of a processor according to an embodiment of the present invention;

FIG. 2 is a block diagram showing a configuration example of a register file included in the processor shown in FIG. 1;

FIG. 3 is a diagram showing an input/output port of a register element included in the register file shown in FIG. 2;

FIG. 4 is a block diagram showing a configuration example of the register element included in the register file shown in FIG. 2;

FIG. 5 is an operation logic table regarding a shift operation of the register element;

FIGS. 6A and 6B are diagrams showing a register operation in accordance with a register shift instruction;

FIG. 7 is a flow chart showing a load processing of unaligned data block by the processor according to the embodiment of the present invention;

FIG. 8 is a diagram showing a specific example of the load processing of the unaligned data block by the processor according to the embodiment of the present invention;

FIG. 9 is a diagram showing a load processing of unaligned data block by a processor according to the related art; and

FIG. 10 is a diagram showing the load processing of the unaligned data block by the processor according to the related art.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

The specific embodiment to which the present invention is applied will now be described in detail with reference to the drawings. The same components are denoted by the same reference symbols in the drawings, and the overlapping description thereof will be omitted for the sake of clarity.

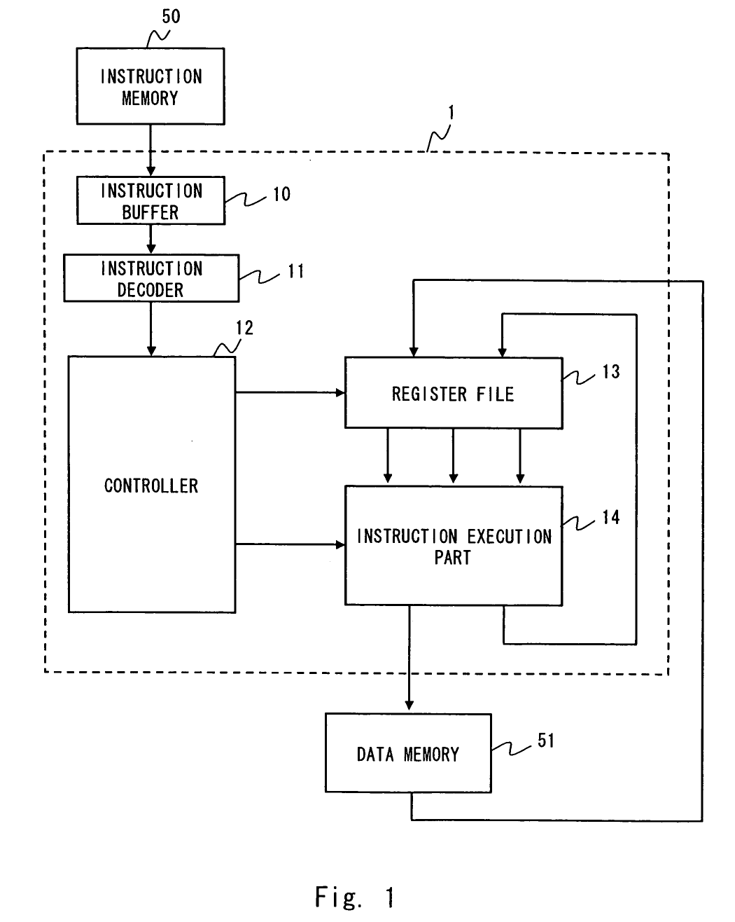

FIG. 1 is a block diagram showing a whole configuration of a processor 1 according to an embodiment of the present invention. In FIG. 1, an instruction buffer 10 temporarily stores an instruction fetched by an instruction memory 50. An instruction decoder 11 reads out the instruction stored in the instruction buffer 10, determines a type of the instruction, and obtains an instruction operand. A controller 12 outputs data or control signals, or both of them to a register file 13 and an instruction execution part 14 in accordance with the type of the instruction and the instruction operand obtained by the instruction decode. The register file 13 and the instruction execution part 14 will be described later in detail.

The register file 13 is a set of a plurality of registers. In the present embodiment, the register file 13 is regarded as including 32 registers R0 to R31. Each register length of the registers R0 to R31 is 64 bits. It is noted that the register number and the register length included in the register file 13 is only an example. The registers R0 to R31 can be variously employed such as an accumulator storing input data and output data of the instruction execution part 14, or an address register performing an address assignment in accessing a data memory 51. The registers R0 to R31 store data loaded from the data memory 51 into the processor 1 for a processing.

Further, the register file 13 is able to shift the held data among a plurality of registers selected from the registers R0 to R31. The configuration example of the register file 13 allowing the data shift among the registers will be described later.

The instruction execution part 14 executes processing in accordance with the instruction decoded in the instruction decoder 11. To be more specific, the instruction execution part 14 includes a plurality of execution units, and executes the decoded instruction in the execution unit suitable for the instruction in accordance with the control made by the controller 12. For example, when the instruction designating the execution of the processing such as an Add instruction, MAC (Multiply and Accumulation) instruction is decoded, the instruction execution part 14 executes the designated processing using the data supplied from the register file 13. Further, when the load instruction or the store instruction is decoded, the instruction execution part 14 generates a destination address of the data memory 51 to access the data memory 51. The specific example of the execution unit included in the instruction execution part 14 includes a floating-point arithmetic unit, an integer arithmetic unit, and a load/store unit. Alternatively, the instruction execution part 14 may include a dedicated execution unit which is specialized in a specific processing (digital filter operation, for example).

Although FIG. 1 shows the instruction memory 50 and the data memory 51 that are logical units. For example, each of them can be configured by a ROM (Read Only Memory), an SRAM (Static Random Access Memory), a DRAM (Dynamic Random Access Memory), a flash memory, or the combinations thereof.

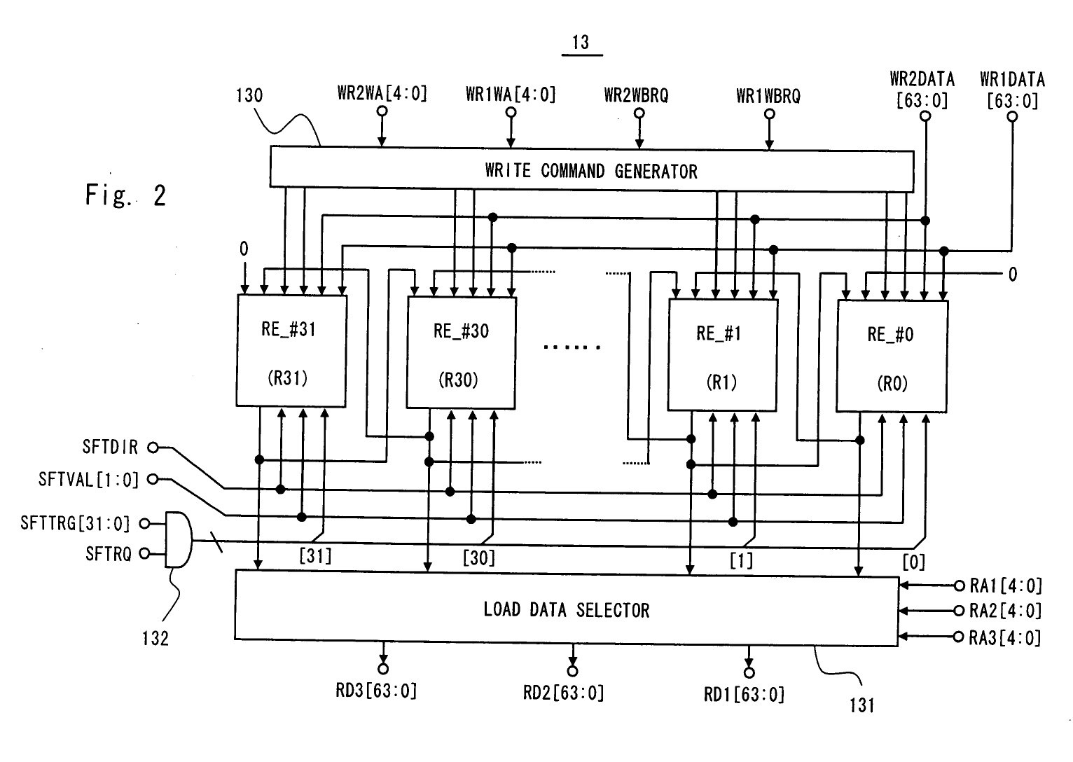

Hereinafter, a configuration example and a specific operation of the register file 13 will be described with reference to FIGS. 2 to 6. FIG. 2 shows an overall configuration of the register file 13. First, signals supplied to terminals shown in FIG. 2 will be described.

WR1DATA[63:0] is 64-bit data input from the instruction execution part 14 to the register file 13. WR2DATA[63:0] is 64-bit data input from the data memory 51 to the register file 13. WR1WA[4:0] and WR2WA[4:0] are write addresses of the register file 13. WR1WBRQ and WR2WBRQ are 1-bit logic signals indicating presence or absence of write back request to the register file 13.

RD1[63:0] to RD3[63:0] are data read out from the registers R0 to R31. RA1[4:0] to RA3[4:0] are load addresses of the register file 13. Although the register file 13 is regarded as being capable of simultaneously supplying three data to the instruction execution part 14 in FIGS. 1 and 2, this configuration is merely an example.

SFTRQ is a 1-bit logic signal indicating presence or absence of execution request of the shift operation to the register file 13. SFTTRG[31:0] is a signal designating the register which is the target of the shift operation of the registers R0 to R31. SFTDIR is a 1-bit signal designating a direction of the data shift. Then SFTVAL[1:0] is a signal designating a data shift amount.

A write command generator 130 receives WR1WBRQ or WR2WBRQ, which is a write back request to the register file 13, and write address WR1WA[4:0] or WR2WA[4:0]. Then, the write command generator 130 outputs the WR1TRG signal to the register corresponding to the write address WR1WA[4:0] when WR1WBRQ is 1. The write command generator 130 outputs the WR2TRG signal to the register corresponding to the write address WR2WA[4:0] when WR2WBRQ is 1. The WR1TRG signal and the WR2TRG signal are trigger signals indicating fetching of the WR1DATA[63:0] or WR2DATA[63:0] to the registers R0 to R31.

The load data selector 131 receives the load address RA1[4:0]. Then the load data selector 131 selects the register corresponding to the RA1[4:0] from among the registers R0 to R31 and outputs the stored value of the selected register as the load data RD1[63:0]. Similarly, the load data selector 131 receives the load addresses RA2[4:0] and RA3[4:0], and outputs the stored values of the registers corresponding to the addresses as RD2[63:0] and RD3[63:0], respectively.

An AND circuit 132 calculates logical AND between 1-bit signal SFTRQ and each bit of 32-bit signal SFTTRG[31:0], and outputs the calculation result as 32-bit data. In the configuration example of FIG. 2, when the SFTRQ signal is “1”, it means that there is a request for executing the shift operation. Further, each bit of the SFTTRG[31:0] corresponds to each of the registers R0 to R31. In other words, when one bit included in the SFTTRG[31:0] is “1”, it means that the register corresponding to the bit is the target of the shift operation.

Each of the registers R0 to R31 can hold data of 64-bit length. The registers R0 to R31 can selectively connect the adjacent registers and can perform the data shift operation between the connected registers. In FIG. 2, the registers R0 to R31 including such a data shift function are denoted by the register elements RE_#0 to RE_#31.

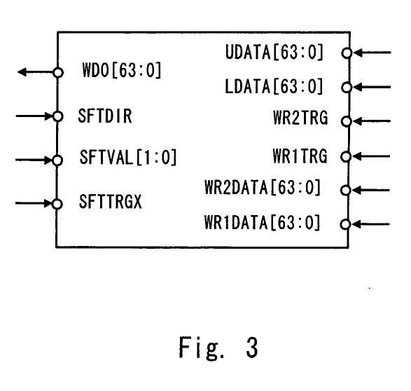

FIG. 3 shows signals input and output to and from each terminal of the register elements RE_#0 to RE_#31 in FIG. 2. In FIG. 3, SFTTRGX means 1-bit signal of 32-bit signal output from the AND circuit 132 described above. For example, SFTTRGX input to the register element RE_#1 corresponding to the register R1 is the logic AND between SFTTRG[1] and SFTRQ. Each register elements RE_#0 to RE_#31 executes the data shift operation when the input SFTTRG is “1”.

The WDO[63:0] output terminal outputs 64-bit data held in the register element. The LDATA[63:0] terminal receives 64-bit data held in the lower-side register. Further, The UDATA[63:0] terminal receives 64-bit data held in the upper-side register. For example, the LDATA[63:0] terminal of the register R1 (RE_#1) receives 64-bit data held in the register R0. The UDATA[63:0] terminal of the register R1 (RE_#1) receives 64-bit data held in the register R2.

In the configuration of FIG. 2, 0 is input to the LDATA[63:0] input terminal of the least-significant register R0 (RE_#0) and the UDATA[63:0] input terminal of the most-significant register R31 (RE_#31). However, this configuration is merely an example, and all the bits supplied to two input terminals can be made 1. Alternatively, the LDATA[63:0] input terminal of the register R0 (RE_#0) may be connected to the WDO[63:0] output terminal of the register R31 (RE_#31), and the UDATA[63:0] input terminal of the register R31 (RE_#31) may be connected to the WDO[63:0] output terminal of the register R0 (RE_#0).

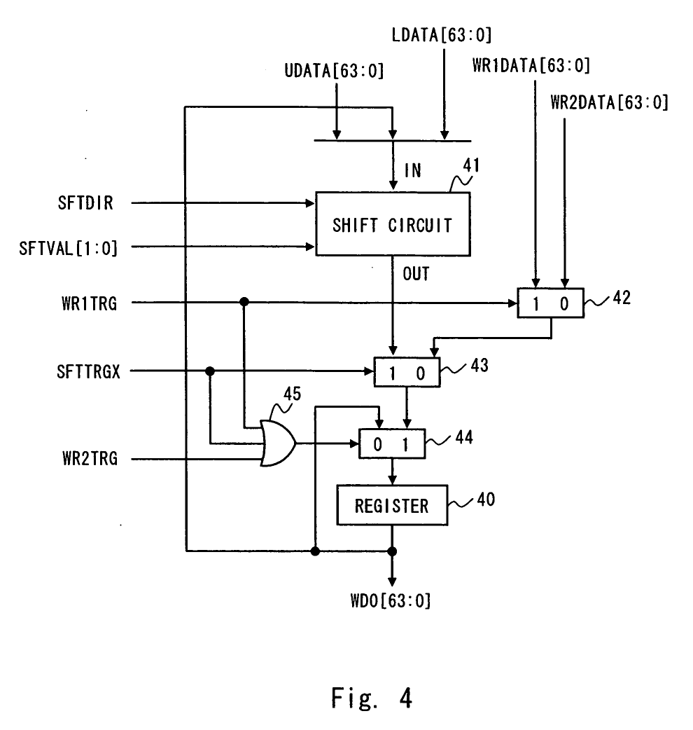

FIG. 4 shows one example of a configuration of the register elements RE_#0 to RE_#31. FIG. 4 is a block diagram showing a configuration example of one register element. The register 40 in FIG. 4 has a register length of 64 bits, which means the register 40 can hold 64-bit data.

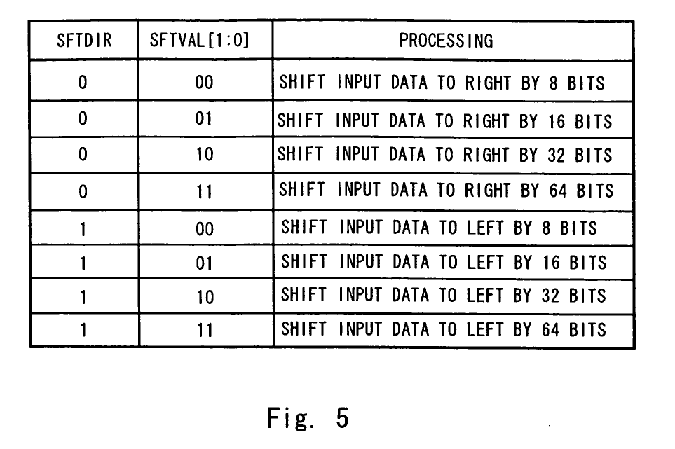

A shift circuit 41 receives 64-bit data held in the register 40, 64-bit data (LDATA[63:0]) held in the lower-side register element, and 64-bit data (UDATA[63:0]) held in the upper-side register element. Then the shift circuit 41 executes the shift operation of 192-bit data in which these data are connected together. The data shift direction and the data shift amount in the shift operation performed in the shift circuit 41 is determined in accordance with the SFTDIR signal and SFTVAL[1:0] input to the shift circuit 41. FIG. 5 shows a specific example of a relationship between combination of the SFTDIR and the SFTVAL[1:0], and the operation performed in the shift circuit 41. Although the data shift amount is set as 8 bits, 16 bits, 32 bits, and 64 bits in FIG. 5, this is merely an example. In summary, the data shift amount may be properly designed in accordance with the word length of the data memory 51, the register length of the registers R0 to R31, and a content of data processing performed in the instruction execution part 14.

A selector 42 receives WR1DATA[63:0] and WR2DATA[63:0]. Then the selector 42 selects and outputs WR1DATA[63:0] when the WR1TRG supplied from the write command generator 130 is “1”, and selects and outputs WR2DATA[63:0] when the WR1TRG is “0”.

A selector 43 receives the output data of the shift circuit 41 and the output data of the selector 42. Then the selector 43 selects and outputs data supplied from the shift circuit 41 when the SFTTRGX supplied from the AND circuit 132 is “1”, and selects and outputs data supplied from the selector 42 when the SFTTRGX is “0”.

A selector 44 receives the data held in the register 40 and the output data of the selector 43. Then the selector 44 selects and outputs the data held in the register 40 when 1-bit logic signal supplied from an OR circuit 45 is “0”. As shown in FIG. 4, the output data of the selector 44 is input to the register 40. Accordingly, when 1-bit logic signal supplied from the OR circuit 45 is “0”, then the stored value of the register 40 is not updated, and old value is continuously held. On the other hand, when 1-bit logic signal supplied from the OR circuit 45 is “1”, then the selector 44 selects the output data of the selector 43, which is supplied to the register 40.

The OR circuit 45 calculates logical OR among the WR1TRG, the WR2TRG and the SFTTRGX and supplies the calculation result to the control terminal (not shown) of the selector 44. Note that the WR1TRG and WR2TRG are the trigger signals indicating execution of the write operation into the register 40, and the SFTTRGX is the trigger signal indicating execution of the data shift operation.

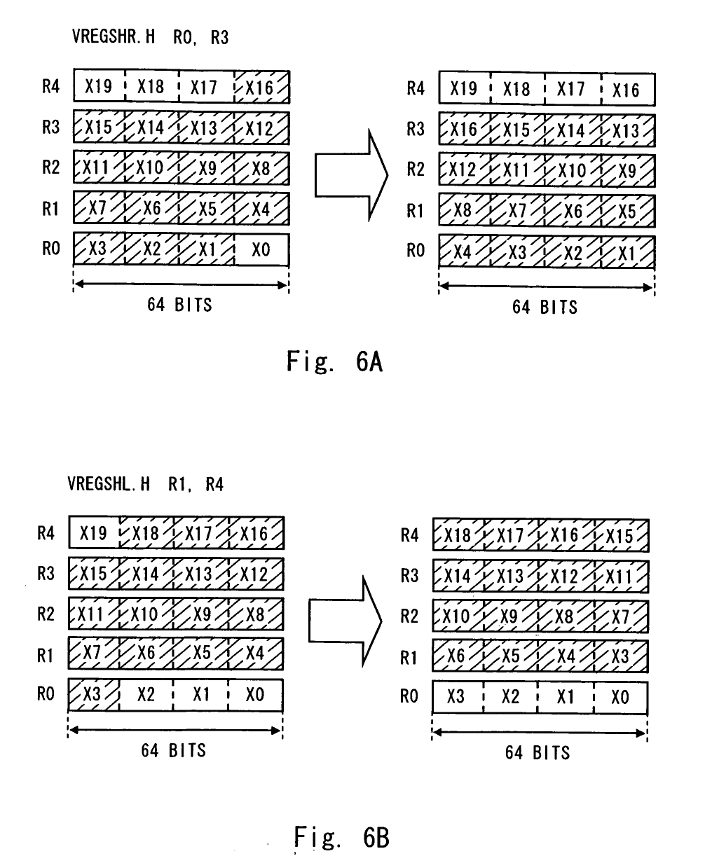

Now, the specific example of the data shift operation of the register file 13 will be described. FIG. 6A shows stored values of the registers R0 to R4 before and after the data shift operation in accordance with a right shift instruction (VREGSHR.H instruction) indicating the execution of the data shift operation in the right direction. When the VREGSHR.H instruction is decoded by the instruction decoder 11, the controller 12 supplies signals of the above-described SFTRQ, SFTTRF[31:0], SFTDIR, and SFTVAL[1:0] to the register file 13. Then the data shift operation is performed among the register elements RE_#0 to RE_#31 according to these signals.

The right shift instruction denoted by mnemonic “VREGSHR.H R0, R3” shown in FIG. 6A is an instruction indicating the execution of the right data shift by 16 bits among four registers from the register R0 designated as the first operand to the register R3 designated as the second operand. The right data shift of the register file 13 is performed in accordance with the instruction, so that the stored value of the register file 13 changes from the state before the data shift which is shown in the left side of FIG. 6A to the state after the data shift which is shown in the right side of FIG. 6A. Due to the instruction, the unaligned data block X1 to X16 are stored with being aligned in the registers R0 to R3. The data shift of the register file 13 is selectively performed among the registers designated as the operand of the right shift instruction (VREGSHR.H instruction). Therefore, the stored value of the register R4 which is not the target of the data shift does not change in FIG. 6A.

On the other hand, FIG. 6B shows stored values of the registers R0 to R4 before and after the data shift operation in accordance with a left shift instruction (VREGSHL.H instruction) indicating the execution of the data shift operation in the left direction. The left shift instruction denoted by mnemonic “VREGSHL.H R1, R4” shown in FIG. 6B is an instruction indicating the execution of the left data shift by 16 bits among four registers from the register R1 designated as the first operand to the register R4 designated as the second operand. The left data shift of the register file 13 is performed in accordance with the instruction, so that the stored value of the register file 13 changes from the state before the data shift which is shown in the left side of FIG. 6B to the state after the data shift which is shown in the right side of FIG. 6B. Due to the instruction, the unaligned data block X3 to X18 are stored with being aligned in the registers R1 to R4. The data shift of the register file 13 is selectively performed among the registers designated as the operand of the left shift instruction (VREGSHL.H instruction). Therefore, the stored value of the register R1 which is not the target of the data shift does not change in FIG. 6B.

As stated above, the processor 1 can selectively perform the data shift among the registers R0 to R31 included in the register file 13 where the data loaded from the data memory 51 is stored. A procedure for effectively performing the load processing of the unaligned data block in the processor 1 will be described hereinafter in detail.

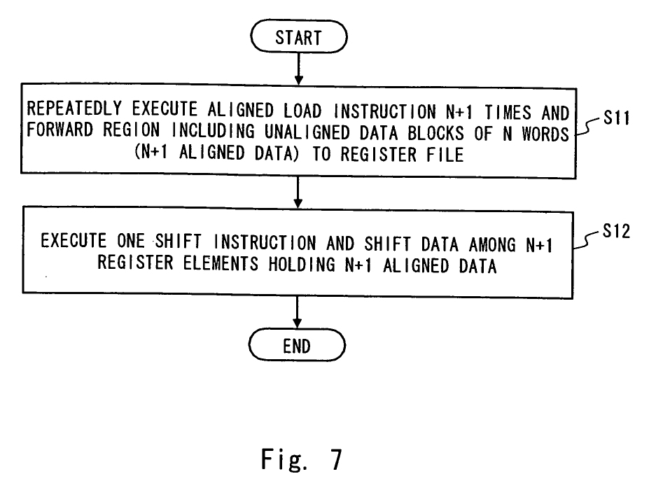

FIG. 7 is a flow chart showing a schematic procedure of the load processing of the unaligned data block whose data length is N words. First, in step S11, an aligned load instruction for loading the aligned data from the data memory 51 is repeatedly performed for N+1 times so as to transmit the N+1 aligned data in a range including the unaligned data block of N words from the data memory 51 to the register file 13. Then one shift instruction is performed in step S12 so as to perform the data shift among N+1 registers holding the N+1 aligned data.

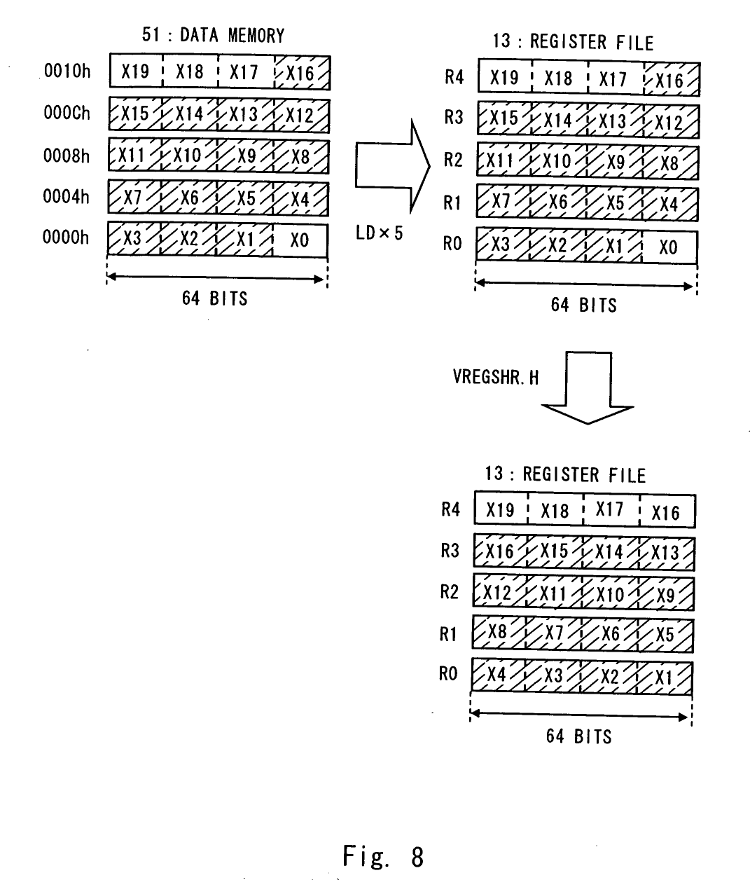

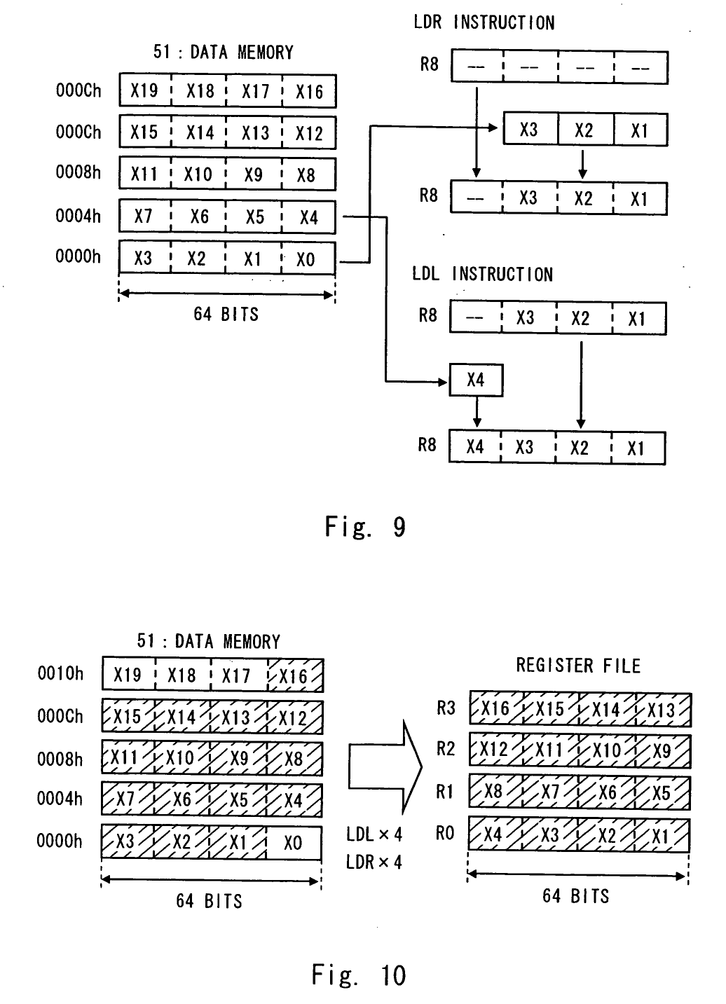

The specific example of the load processing of the unaligned data block will be described in detail with reference to FIG. 8 for the sake of clarity. FIG. 8 shows a process from when the unaligned data block X1 to X16 whose data length is four words are read out from the data memory 51 to when the unaligned data block X1 to X16 are stored with being aligned in the registers R0 to R3.

A left upper part of FIG. 8 shows five-word data X0 to X19 held in 0000h to 0013h of the data memory 51. As shown in the step S11, the LD instruction for loading the aligned data is executed five times so that the five-word aligned data including the unaligned data block X1 to X16 whose data length is four words is forwarded to the registers R0 to R4. A right upper part of FIG. 8 shows the stored values of the registers R0 to R4 after the step S11 has been completed. In the state of the right upper part of FIG. 8, data boundaries of the unaligned data block X1 to X16 do not correspond to boundaries of the registers R0 to R3. Next, as shown in the step S12, the shift instruction (VREGSHR.H instruction) indicating the execution of the right data shift of 16 bits in the register file 13 is executed once, so that the unaligned data block X1 to X16 are stored with being aligned in the registers R0 to R3 (see right lower part of FIG. 8).

According to the data load method in the processor 1 of the present embodiment described with reference to FIGS. 7 and 8, it is possible to execute the aligned load processing of the unaligned data block by the N+1 aligned load instructions and one shift instruction, or N+2 instructions. That is, the processor 1 is able to execute the aligned load of the unaligned data block with fewer instructions than in the procedure in which the unaligned load instruction needs to be performed 2N times as described in the “Description of Related Art”. Since the processor 1 can prevent the increase of the execution time needed for the aligned load of the unaligned data block, the processor 1 is suitably used for the process including multiple processings employing the unaligned data block such as a digital filter processing.

FIG. 1 shows a configuration in which the instruction memory 50 and the data memory 51 are provided outside the processor 1. However, at least one of the instruction memory 50 and the data memory 51 may be provided in the processor 1 such as the microprocessor which is integrated in one chip including the instruction memory 50 or the data memory 51, or both of them, for example. In summary, the present invention can be applied to the processors of various implementations without being limited to the specific implementation shown in FIG. 1.

It is apparent that the present invention is not limited to the above embodiments, but may be modified and changed without departing from the scope and spirit of the invention.

What is claimed is:

1. A processor comprising:
an instruction decoder being adapted to decode an instruction;
an instruction execution part being adapted to execute processing corresponding to the instruction decoded by the instruction decoder; and
a register file being capable of storing load data from a data memory and supplying input data to the instruction execution part, the register file comprising a plurality of registers, each of the resisters being capable of holding a plurality of bits of data, the register file being configured to update the data held by the plurality of registers by shifting the data held by the plurality of registers among the plurality of registers.

2. The processor according to claim 1, wherein the register file selectively performs a data shift operation between at least one target register which is a target of data shift of the plurality of registers and a adjacent register adjacent to the target register to selectively update the data held in the target register.

3. The processor according to claim 1, further comprising a controller being adapted to output a control signal which instructs the register file to execute a data shift operation upon decoding of a shift instruction indicating execution of the data shift operation of the register file by the instruction decoder.

4. The processor according to claim 3, wherein the control signal includes a designation of at least one target register which is a target of data shift of the plurality of registers, a designation of a data shift direction, and a designation of a data shift amount.

5. The processor according to claim 3, wherein an operand part of the shift instruction includes a designation of at least one target register which is a target of data shift of the plurality of registers.

6. The processor according to claim 1, wherein each of the plurality of registers includes a shift circuit performing a shift operation on coupled data obtained by coupling at least one held data of adjacent two registers and its own held data, each of the plurality of registers being capable of updating its own held data using the coupled data after the shift operation.

7. A data load method reading out unaligned data block from the data memory connected to the processor according to claim 1 into the register file, the unaligned data block having a data length twice or more larger than a register length of each of the plurality of registers and having a data boundary not corresponding to a word boundary of the data memory, the data load method comprising:
repeatedly executing an aligned load instruction indicating a load of aligned data to forward a plurality of aligned data in a range including the unaligned data block from the data memory to the register file; and
executing a shift instruction indicating execution of a data shift operation of the register file to shift held data among the registers holding the plurality of aligned data and to store the unaligned data block with being aligned in the plurality of registers.

8. The data load method according to claim 7, wherein the data shift of the register file is selectively performed among the registers holding the unaligned data block of the plurality of registers.

9. The data load method according to claim 7, wherein an operand part of the shift instruction includes a designation of two registers of both ends that are targets of data shift of the plurality of registers, and the data shift of the register file is performed by selectively coupling the registers interposed between the two registers designated as the operand part.
